(19) United States
(12) Patent Application Publication
(10) Pub. No.: US 2026/0346974 A1
(43) Pub. Date: Nov. 5, 2026

(54) IMPROVEMENT OF THE LOCKING/UNLOCKING MECHANISM OF AN AIRCRAFT DOOR WITH LATERAL ESCAPE OF THE STOPS

(71) Applicant: LATECOERE, Toulouse (FR)

(72) Inventors: Sébastien DEVILLEZ, SAINT JEAN (FR); Stephane Quement, Toulouse (FR); Martin Gildas, LUnion (FR)

(73) Assignee: LATECOERE, Toulouse (FR)

(21) Appl. No.: 19/120,765

(22) PCT Filed: Sep. 30, 2023
(86) PCT No.: PCT/EP2023/077187

§ 371 Date: Apr. 12, 2025

(30) Foreign Application Priority Data
Oct. 13, 2022 (FR) FR2210548

(51) Int. Cl. B64C 1/14

(52) U.S. Cl. CPC B64C 1/143

(57) ABSTRACT

Locking/unlocking mechanism for controlling the passage of an aircraft door, with lateral escape of the stops, from the closure position to the unlocking position, the mechanism having: a guide track extending along a plane substantially orthogonal to a control shaft and having an opening; an actuating finger fixed on a support arm, the actuating finger being adapted to cooperate with the guide track; a mechanical transmission suitable for driving a movement of the actuating finger when the control shaft is actuated in rotation, the transmission having a fork arranged facing the guide track and connected to the control shaft and including two actuating branches and an opening; the two actuating branches of the fork meet in a loop which is offset transversely with respect to the longitudinal axis of the branches, and the closed end of the guide track opposite its opening is provided with a loop of enlarged diameter.

### TECHNICAL FIELD

The invention relates to the field of aeronautics and, more specifically, to aircraft doors with lateral escape of the stops and is concerned with an improvement of their integrated locking and unlocking mechanisms.

An aircraft usually has several openings in its fuselage, to allow access to the cabin or cargo holds. These openings are equipped with doors whose locking/unlocking mechanism must ensure the strength of the lock and the tightness of the door during flight. In addition, the opening must be simple and quick to carry out by the flight crew, either from inside the aircraft or from the outside by rescue teams. Resistance to the pressure differential between the inside and outside of the cabin is achieved by means of stops installed around the edges of the door panel and its frame.

### PRIOR ART

There are already aircraft doors with:
a panel comprising a door structure, an external wall fixed to this structure and door stops;
a frame comprising a door frame intended to be fixed to the fuselage of the aircraft and comprising frame stops;
a support arm connected to the panel and having a swivel mounted end on the door frame, said support arm and the panel being movable between a closing position in which the panel closes the door frame, the door stops being then locked against the frame stops, an intermediate release position in which the door stops are free from the frame stops and an opening position in which the panel is out of the door frame.

Such a door described in patent application US2001/0070416 is provided with a locking/unlocking mechanism adapted to control the change from the closed position to the unlocking position and vice versa.

This locking/unlocking mechanism comprises, for its operation, an internal lever or handle and an external lever or handle which are mounted on the door structure by being movable between a locking position and an unlocking position.

According to some door opening and closing kinematics, as described in U.S. Pat. No. 4,720,065, the door opens and closes in a circular translation, thus holding the door parallel to the frame.

The present invention focuses on aircraft doors that are unlocked by lateral movements of the panel allowing the door stops to be released from the frame stops without the use of vertical movements of the panel, as described in the U.S. patent application US 2021/0387713. These lateral movements are defined here as movements in a longitudinal direction parallel to the longitudinal axis of the aircraft.

WO 2020/253986 describes such an aircraft door in which the locking/unlocking mechanism comprises:
a control shaft extending along a substantially vertical axis by being mounted on the door structure by a pivot connection around the axis of the control shaft, the internal lever and the external lever being connected transversely to the control shaft so that an action on one of the levers causes the control shaft to rotate around its axis;
a guide track attached to the panel and extending according to a plane substantially orthogonal to the control shaft and having an opening at its end;
an actuation finger attached to the support arm and suitable for cooperating with the guide track;
a mechanical transmission adapted to cause a displacement of the actuation finger when the control shaft is operated in rotation.

This specific locking/unlocking mechanism has two configurations, respectively,
an actuation configuration corresponding to the angular travel of the levers between their locking position and their unlocking position and in which, the rotation of the control shaft then causing the actuation finger to move along the guide track, and;
a release configuration in which the levers are in the release position and in which the actuating finger is moved between a first position where it is placed at the opening of the guide track and a second position where it is outside the guide track, the panel being then in the open position.

In this locking/unlocking mechanism, the mechanical transmission has a fork arranged facing the guide track and connected to the control shaft.

This fork extends in a plane substantially orthogonal to the control shaft and is mounted pivotally on the door structure around an axis roughly parallel to the control shaft. The fork has two actuation arms and an opening at the end.

In the release configuration, the fork opening is arranged facing the guideway opening.

In the actuation configuration, the actuating finger is inserted into both the guide track and the fork in such a way that the pivoting of the fork causes the actuating finger to move along the guide track.

For this purpose, the actuating finger is, on the one hand, mounted on an actuation arm which is integral to the support arm and which is arranged between the fork and the guide track and, on the other hand, has a double roller extending transversely on either side of the actuation arm.

In addition, the mechanical transmission has a cam that rotates the control shaft and a connecting rod that connects the cam to the fork and is designed to drive the fork to rotate when the cam and the drive shaft are rotated.

### DISCLOSURE OF THE INVENTION

Natural phenomena, such as freezing rain or supercooled water encountering a cold obstacle (zero degrees Celsius or less), result in the appearance of a layer of ice covering the fuselage and door. This layer of ice, potentially present when the doors are opened, creates a blocking mechanical connection between the panel and the frame that prevents the door from being unlocked.

Current “semi-plug” doors use a vertical upward movement to disengage the stops and this kinematics requires sufficient space between the upper part of the door and the fuselage.

If such a door is covered with ice, it is then necessary to break it by pulling it in the lower part of the door (which requires only small forces), to shear the glass present on the sides which, on the other hand, requires significant forces but compatible with a conventional door mechanism and also to break the glass in compression in the upper part, which normally requires very high forces but the use of a seal blocking the door in its upper part makes the glass in this area brittle.

However, a lateral escape door kinematics of the stops is achieved by a combination of translations in longitudinal and transverse planes and vertical axis rotation. This kinematics has the advantage of allowing the fuselage skin to be cut very close to that of the door skin without additional clearance and thus reducing the size of the opening in the fuselage with equivalent passage dimensions.

But, with such a door, any horizontal movement of the door parallel to the fuselage will be impossible since on one or other of its side edges, the door will compress against the ice and will be blocked, which is problematic both ergonomically and safely.

On the other hand, a displacement of one of these edges towards the inside of the cabin will allow the ice to break on this edge and then on the other by dynamic effect because the ice offers only a small resistance to a transverse force.

However, it is necessary that this inward-facing force on the panel be produced directly by the locking/unlocking mechanism, since the use of a ramp on the fuselage would require a lateral displacement beforehand to generate this internal displacement.

In addition, current technical certification standards require a minimum opening force as soon as the pressure differential between the inside and outside of the fuselage has reached a given value in order to avoid the risk of accidental opening. This pressure must therefore return to the lever, when opening, a force greater than the specified minimum.

The invention is therefore intended to improve the aircraft doors known from the prior art with lateral escape of the stops and, in particular, to modify their locking/unlocking mechanism to incorporate means for breaking any ice that may be present between the panel and the door frame during a preliminary phase of door opening.

In this context, the invention aims to propose an improvement of the mechanical transmission means ensuring a preliminary displacement of the door oriented transversely inwards to break the ice and allow the subsequent action of the release mechanism thus ensuring the conformity of the door with the certification standards in force.

This purpose is achieved by means of a locking/unlocking mechanism for controlling the passage of a lateral escape aircraft door from the stops from the closed position to the unlocking position and vice versa, said mechanism comprising:
an internal lever and an external lever mounted on the door and being mobile between a locking position and an unlocking position;
a control shaft extending along a substantially vertical axis, being mounted on the door by a pivot link, the internal lever and the external lever being connected transversely to the control shaft so that an action on one of the levers causes the control shaft to rotate around its axis;
a guide track extending along a plane substantially orthogonal to the control shaft and having an opening at its end;
an actuation finger attached to a support arm, this actuation finger being adapted to cooperate with the guide track;
a mechanical transmission adapted to cause the actuation finger to move when the control shaft is operated in rotation, said transmission comprising a fork arranged facing the guide track and connected to the control shaft and comprising two actuation arms and an opening at its end in such a way that, in an actuation configuration corresponding to the angular travel of the levers between their locking and unlocking position, the pivoting of the fork causes the actuating finger to move along the guide track and, in a release configuration where the levers are in the unlocking position, the opening of the fork is arranged facing the opening of the guide track, characterized in that the two actuation arms of the fork meet opposite its opening in a loop that is offset transversely by in relation to the longitudinal axis of the branches and in that the closed end of the guide track opposite its opening is provided with a loop of enlarged diameter, the wall of which delimits, with the actuating finger in the closing position of the door, a clearance the adjustment of which makes it possible to produce a force exerted on the door inwards during a preliminary phase of unlocking.

According to an advantageous feature of the invention, the mechanism comprises a cam rotating to the control shaft.

According to another feature of the mechanism of the invention, the fork is driven in rotation by a shaft which is itself driven in rotation by the mechanical transmission.

In addition, the vertical axis of the fork loop is offset from the shaft axis to produce a mechanical driving effect.

According to a specific design variant, the mechanical transmission comprises a belt mounted, on the one hand, around the said shaft and, on the other hand, on an intermediate mechanical gearbox engaged with a roller inserted in a path provided in the said cam.

According to yet another feature of the mechanism of the invention, in its actuation configuration, the actuating finger is inserted both in the guide track and in the fork.

Preferably, this actuation finger has a double roller.

The invention provides that, in the configuration of the release of the mechanism, the opening of the fork is disposed facing the opening of the guide track.

In addition, the actuating finger is never positioned in the fork loop regardless of the position of the mechanism.

Another object of the invention is an aircraft door with lateral escape of the stops equipped with a locking/unlocking mechanism as defined above.

The mechanism of the invention makes it possible to generate an initial displacement of one edge of the panel towards the inside of the cabin before starting the unlocking phase, which ensures the breaking of the ice around the door, and then to provide the movement necessary for the complete release of the stops.

For this purpose, the invention uses the fork to ensure the inward movement and the cam is designed to allow this movement even if the door is blocked in the longitudinal direction by the glass.

Another advantage of the invention is that this inward movement of the door prevents accidental opening because the force exerted on the lever (or handle) to open the door is greater than 300 lbs as soon as the pressure differential is above 2 psi.

Other advantages of the invention lie in the reduction of the dimensions of the fuselage opening, the elimination of the flap, the reduction of the fuselage ramps, the reduction of the energy expenditure of opening in normal situations and the better compactness of the locking/unlocking mechanism.

### PRESENTATION OF THE FIGURES

Other features and advantages of the invention will be apparent from the following non-exhaustive description, with reference to the attached drawings in which:

FIG. 1 is a side perspective view of a preferred embodiment of the locking/unlocking mechanism of the invention fitted to a side exhaust door of the stops.

FIG. 2 is a perspective view from below of the locking/unlocking mechanism in FIG. 1.

FIG. 3 is a partial view from below of the mechanism in FIG. 1, in the locked position.

FIG. 4 is a detail view of the locking mechanism of the invention in the position shown in FIG. 3 and illustrating the cooperation between the guide track and the actuating finger.

FIG. 5 is a partial view from below of the mechanism in FIG. 1 and illustrates a first step in a sequence of unlocking the door intended to break the ice.

FIG. 6 is a partial view from below of the mechanism in FIG. 1 and illustrates a second step in a door unlocking sequence.

FIG. 7 is a partial view from below of the mechanism in FIG. 1 and illustrates a third step in a door unlocking sequence.

FIG. 8 is a partial view from below of the mechanism in FIG. 1 and illustrates a fourth step in a door unlocking sequence.

### DETAILED DESCRIPTION

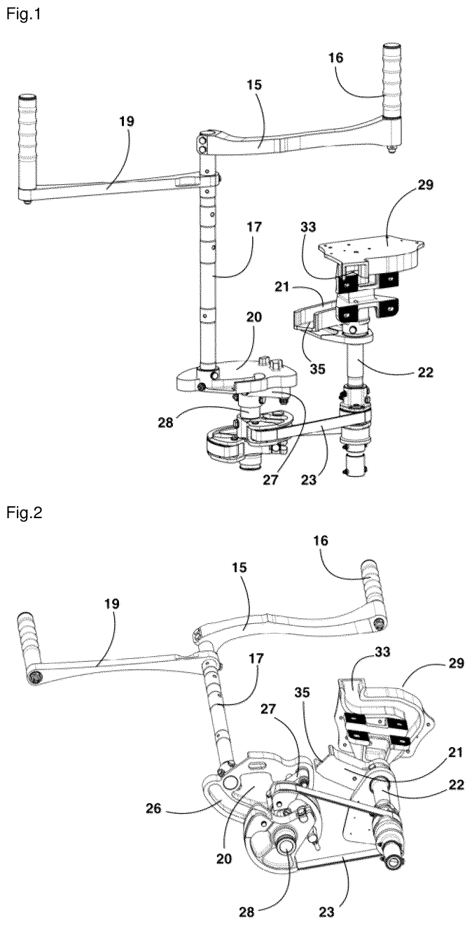

FIGS. 1 and 2 are perspective views of a preferred embodiment of the invention's locking/unlocking mechanism shown alone and applied to an aircraft door having a so-called “side exhaust” mode of operation. This mechanism is described and illustrated in patent application WO2020/253986 to which the following description of the improvement according to the present invention refers.

This operation consists of the door being unlocked by lateral and rotating movements around the vertical axis of the panel allowing the door stops to be released from the stops of the frame. These lateral movements are defined here as movements in a longitudinal direction parallel to the longitudinal axis of the aircraft.

The improvement according to the invention integrates, into the kinematics of this mechanism, movements perpendicular to this axis, one of which is directed inwards to break the ice and another is directed outwards to allow the panel to exit its frame.

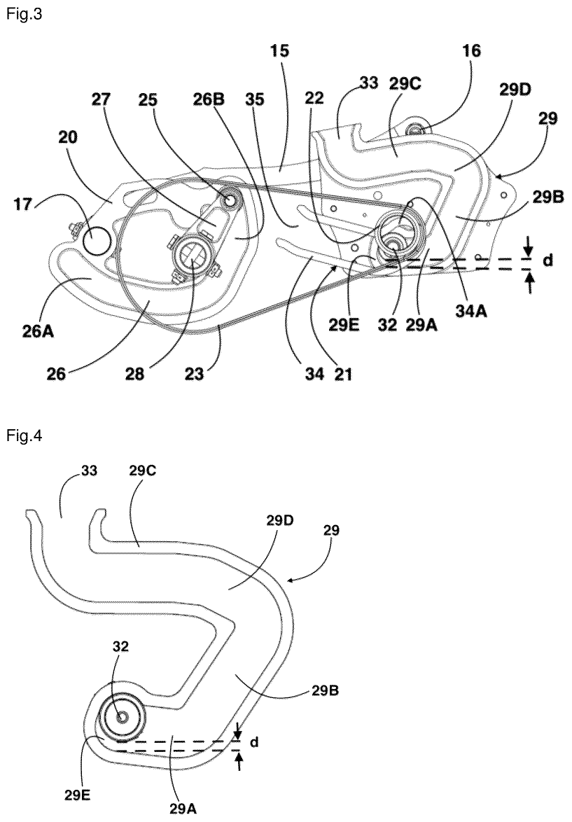

FIGS. 3 to 8 are figures illustrating the successive configurations of a part of the locking/unlocking mechanism according to the invention from the closed position to the full opening position of the door.

With reference to FIGS. 1 and 2, the locking/unlocking mechanism comprises a control shaft 17 mounted on bearings (not shown) integral to the door structure. The control shaft 17 is mounted rotating on the door structure (not shown), around its longitudinal axis, which extends vertically.

The internal lever 15 extended by a handle 16 and the external lever 19 are directly attached to the control shaft 17 and extend transversely to the shaft and, preferably, perpendicular to this shaft 17. Levers 15, 19 are attached to the control shaft 17 by any means that allows these levers 15, 19 to drive the control shaft 17 in rotation, e.g. by screwing, keying, spline mounting, etc. The internal lever 15, the external lever 19 and the control shaft 17 are thus interconnected, without any means of reduction or movement return. This assembly considerably simplifies and makes the actuation of the mechanism considerably more reliable.

The external lever 19 allows the control shaft 17 to be operated in the same way as the internal lever 15, but is accessible from the outside of the aircraft.

The locking/unlocking mechanism also comprises, as described in the WO2020253986A1, a cam 20 attached to the control shaft 17, at its end opposite to levers 15 and 19. Cam 20 is mounted on the control shaft 17 by any means that allows the cam 20 to rotate when the control shaft 17 is rotated about its longitudinal axis.

The locking/unlocking mechanism also has a fork 21 that extends in a plane perpendicular to the control shaft 17. This fork 21 has a shaft 22 parallel to the control shaft 17 and mounted rotatable on the door structure. The fork 21 is driven in rotation by the shaft 22 which is itself driven in rotation by a belt 23 mounted, on the one hand, around the shaft 22 and, on the other hand, on an intermediate mechanical idler 25 engaged with a roller associated with the cam 20. However, according to a variant of the invention not shown, it is possible to provide that the belt is replaced by the coupling of a connecting rod and a lever or, more generally, by the coupling between the idler shaft and the fork shaft.

Cam 20 has a cam path 26 in which the idler 25 is captive. Fork 21 has two actuation arms 34 which join in a loop 34a as well as an opening 35 at the end of these two branches. The loop 34a is offset transversely in the plane of the fork with respect to the longitudinal axis of the branches 34 while its vertical axis is parallel and offset towards the inside of the fork with respect to the shaft 22.

In addition, the idler 25 of the roller is associated with a lever 27 which is pivoted around a shaft 28 parallel to the control shaft 17. The shaft 28 is connected to the belt 23 via a pulley and is also mounted rotating on the door structure. Lever 27 extends orthogonally to shaft 28 and is intended to restrict the movement of the roller and its idler 25 to an arc centered on shaft 28 and to define the position of the roller in the cam path 26. The roller is intended to drive the shaft 28 in rotation when the cam 20 rotates.

The locking/unlocking device also includes a guide track 29 opposite the fork 21. The guide track is a part that extends in a plane perpendicular to the control shaft 17 and has an internal guide path suitable for guiding the movement of at least one actuating finger.

Between the guide track 29 and fork 21, there is an actuation arm (shown in FIGS. 1 and 2) which is fixed on a support arm (not shown for the sake of simplicity) having at its end an actuation finger which here consists of a double roller 32 (only the double roller 32 is visible) which is inserted both in the guide track 29 and in the fork 21. Thus, the double roller 32 is driven in motion by the fork 21 while travelling along the guide track 29.

The double roller 32 is never positioned in the loop 34a regardless of the position of the locking/unlocking mechanism (see FIG. 3).

FIGS. 3 to 8 are partial and bottom views of the locking/unlocking mechanism according to the invention. These figures show in particular the shapes of the cam path 26 and the guide track 29 (only with the actuating finger 32 in FIG. 4). In these figures, only the internal lever 15 and the inner handle 16 have been shown, it being understood that the external lever 19 is rotatingly attached to the control shaft 17 and therefore has the same behaviour.

Cam Path 26 has a general curvilinear shape with a first range 26a and a second range 26b (FIG. 3).

Guideway 29 has a general C-shaped shape with a first range 29A, a second range 29B, a third range 29C and an intermediate bend 29D between the second range 29B and the third range 29C. The width of guideway 29 is uniform on ranges 29A, 29B, 29C and in elbow 29D and corresponds approximately to the outside diameter of double roller 32 so as to allow it to be moved flexibly on runway 29.

According to the invention, the closed end of the first range 29A is provided with a loop part 29E (FIGS. 3, 4 and 6) of enlarged diameter delimiting with the double roller, in the closing position of the door, a set d (FIGS. 3 and 4). On the other hand, the end of the third range 29C of guideway 29 has an opening 33 through which the double roller 32 can be positioned at the exit of guideway 29. Opening 33 is preferably funnel-shaped to facilitate the reception of the double roller 32 into the guideway 29 when closing and to engage the door when closing, even if the roller is not perfectly opposite the entrance to the guide track.

A process for unlocking the aircraft door, prior to the opening of this door, will now be described with reference to FIGS. 3 to 8 on which the mechanism is illustrated from below, the internal lever 15 located inside the aircraft cabin being represented here on the top of the figures.

In the position in FIGS. 3 and 4, the internal lever 15 is in its locking position which corresponds to the closing position of the door. In this position, idler 25 is stopped at the end of range 26B of cam track 26. At the same time, the double roller 32 is positioned in loop 29E of the closed end of guideway 29 and is wedged at the entrance to loop 34A of fork 21 and therefore at a distance from its end. The offset of the double roller 32 in the direction of the end 35 in relation to loop 34A of fork 21, the clearance d in loop 29E of guideway 29 and the offset of shaft 22 in relation to the vertical axis of loop 34A, thus ensure that a tracking force of the door panel is maintained against its frame in the fuselage, which makes it possible to compress the door seal.

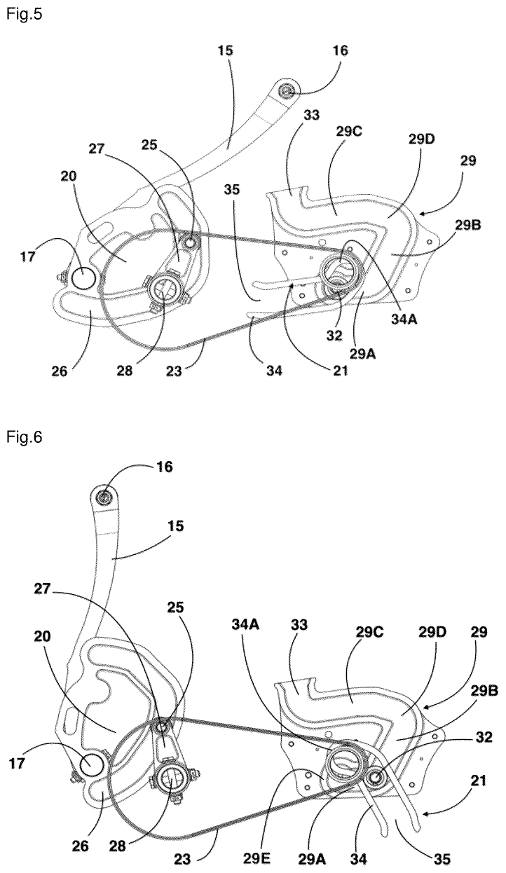

From the locking position in FIG. 3, the internal lever 15 is operated to its unlocking position. FIG. 5 illustrates this first phase of actuation during which the movement of the double roller 32 between the branches 34 of the fork 21 and the adjustment of the clearance d in the loop 29E generate a movement of the edges of the door inwards, thus breaking up any ice present on its periphery. At the same time, fork 21 begins to rotate relative to guideway 29. According to the invention, the displacement of the panel towards the inside of the fuselage is of the order of 9 mm and can be adjusted as needed.

FIG. 6 illustrates a second phase in which the actuation of lever 15 causes the rotation of the control shaft 17 and thus of the cam 20. The rotation of the cam 20 causes the idler 25 to travel a second range.

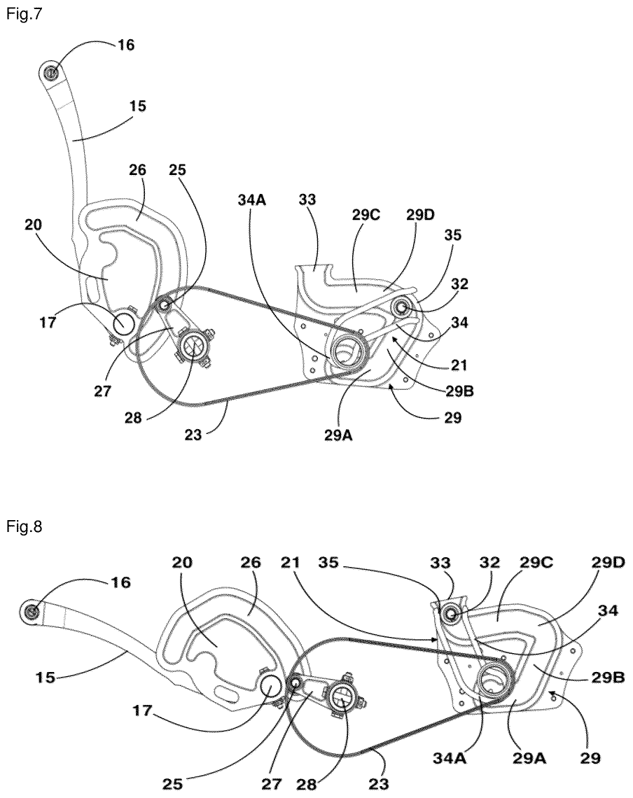

From the position shown in FIG. 6, in a third actuation phase, cam 20 continues its rotation and idler 25 continues its journey in a second range. This third phase of actuation resulted in the position shown in FIG. 7. Fork 21, in its pivot, drove the double roller 32 along the guideway 29. During this movement, double roller 32 travelled the first range 29A and the second range 29B and was now in the bend 29D of guideway 29. As the double roller 32 is directly connected to the support arm, this movement causes the support arm to move in relation to the opening. This movement drives the panel in transverse and lateral directions.

Given the arrangement of the locking/unlocking mechanism of the invention, the displacement of the double roller 32 thus allows the following movements of the panel:-a displacement of the double roller 32 in the range 29C towards the end 33 or in the opposite direction results in a displacement of the panel parallel to the fuselage, respectively, towards the front or towards the rear of the aircraft;—a displacement of the double roller 32 in the range 29B towards the end 33 or in the opposite direction results in the displacement of the panel:—a displacement of the double roller 32 in the range 33 or in the opposite direction results in a displacement of the panel a displacement of the panel in the direction perpendicular to the fuselage, respectively, towards the outside of the aircraft or towards the inside of the aircraft.

The guideway 29 makes it possible to organize the movements of the double roller 32, and therefore of the support arm, to cause the desired movements for the panel, among these possible movements for the panel, which can be combined according to the arrangement of the support arm, the support forearm, the swivel arm, and the swivel forearm.

In this example, with reference to the release strategy shown in FIGS. 3 through 8, the end of the path of the double roller 32 in guideway 29 corresponds to the position shown in FIG. 8. In this position, the opening 35 of fork 21 is opposite the opening 33 of guideway 29 so that the double roller 32 can freely leave fork 21 and guideway 29 through their respective openings 33, 35. Double roller 32 has completed the entire guideway 29 and is now in the release position. This position corresponds to the end of the door unlocking phase and the panel can then be operated by hand.

The invention thus refers to locking/unlocking means capable of causing the panel to move in the longitudinal and transverse directions of the aircraft, it being understood that the skilled person will be able to combine these movements and transform them into rotation according to the desired opening strategy.

The process for locking the door follows the same sequence in reverse. The panel is then manually brought back to the position shown in FIG. 8 where the double roller 32 is then inserted into the opening 35 of the fork 21, as well as into the opening 33 of the guideway 29. The operation of one of the levers 15 and 19 from its unlocking position to its locking position then leads to the actuation phases corresponding, in order, to FIGS. 7, 6, and 5.

The locking/unlocking mechanism thus comprises:
an actuation configuration corresponding to the angular travel of levers 15, 19 between their locking position and their unlocking position, a configuration in which the rotational drive of fork 21 causes the double roller 32 to move along the guide track 29;
a release configuration in which levers 15, 19 are in the unlocking position and the fork opening is arranged facing the guideway 29 opening (from the position in FIG. 8). In this configuration, the double roller 32 is either at its position in FIG. 8 or outside the guide track 29 (position not shown).

Variants of the aircraft door design can be implemented without going beyond the scope of the invention. For example, the actuating gate 32 and the idler 25 may have one or more roller or friction rollers, or any other device that can be trained to travel the guide track 29 or the cam path 26.

In addition, the shape of the guideway 29 can be adapted for other opening and closing strategies than the one given here as an example, by exploiting the possibilities of movements of the panel driven by the possible movements of the operating finger 32.

1. An aircraft door with lateral escape of stops equipped with a locking/unlocking mechanism for controlling the change from a closed position to an unlocking position and vice versa, said mechanism comprising:
an internal lever (15) and an external lever (19), mounted on the door by being movable between a locking position and the unlocking position;
a control shaft (17) extending along a substantially vertical axis, being mounted on the door by a pivot connection, the internal lever (15) and the external lever (19) being connected transversely to the control shaft (17) so that an action on one of the levers (15,19) causes the control shaft (17) to rotate around an axis;
a guideway (29) extending in a plane substantially orthogonal to the control shaft (17) and having an opening at an end (33);
an actuating finger (32) fixed on a support arm, said actuating finger (32) being adapted to cooperate with the guideway (29);
a mechanical transmission adapted to cause a displacement of the actuating finger (32) when the control shaft (17) is operated in rotation, said transmission comprising a fork (21) disposed opposite the guideway (29) and connected to the control shaft (17) and comprising two actuating arms (34) and an opening (35) at the end such that, in an actuation configuration corresponding to the angular travel of the levers (15,19) between their locking position and their unlocking position, the pivoting of the fork (21) causes the actuating finger (32) to move along the guideway (29) and, in a release configuration where the levers (15,19) are in the unlocking position, the opening (35) of the fork (21) is disposed facing the opening (33) of the guideway (29), characterized in that the two actuation arms (34) of the fork (21) meet opposite its opening (35) in a loop (34A) which is offset transversely with respect to the longitudinal axis of the branches (34) and in that the closed end of the guide track (29) opposite its opening (33) is provided a loop (29E) of enlarged diameter, the wall of which delimits, with the actuating finger (32) in the closing position of the door, a clearance (d) the adjustment of which makes it possible to produce an inward force exerted on the door during a preliminary phase of unlocking.

2. The door according to claim 1, further comprising a cam (20) rotating to the control shaft (17).

3. The door according to claim 1, wherein the fork (21) is rotated by a shaft (22) which is itself rotated by said mechanical transmission.

4. The door according to claim 3, wherein the vertical axis of the loop (34A) of the fork (21) is offset with respect to the shaft axis (22) in such a way as to produce a mechanical motor effect.

5. The door according to claim 2, wherein the mechanical transmission comprises a belt (23) mounted, on the one hand, around said shaft (22) and, on the other hand, on a idler (25) engaged with a roller inserted in a path (26) provided in said cam (20).

6. The door according to claim 1, wherein in the actuation configuration, the actuating pinch (32) is inserted both in the guide track (29) and in the fork (21).

7. The door according to claim 1, wherein the actuating finger (32) comprises a double roller.

8. The door according to claim 1 wherein the release configuration the opening (35) of the fork (21) is disposed opposite the opening (33) of the guideway (29).

9. The door according to claim 1, wherein the actuating finger (32) is no positioned in the loop (34A) of the fork (21) regardless of the position of the mechanism.
